(19) United States
(12) Patent Application Publication
(10) Pub. No.: US 2015/0143392 A1
(43) Pub. Date: May 21, 2015

(54) METHOD, APPARATUS AND SYSTEM FOR DETERMINING VIEWER REACTION TO CONTENT ELEMENTS

(71) Applicant: THOMSON LICENSING, Issy de Moulineaux (FR)

(72) Inventors: Fernando Jorge Silveira-Filho, Vanves (FR); Anmol Sheth, San Francisco, CA (US)

(73) Assignee: THOMSON LICENSING, Issy de Moulineaux (FR)

(21) Appl. No.: 14/402,919

(22) PCT Filed: Jun. 13, 2013
(86) PCT No.: PCT/US2013/045639

§ 371 Date: Nov. 21, 2014

Related U.S. Application Data
(60) Provisional application No. 61/659,756, filed on Jun. 14, 2012.

(51) Int. Cl. H04N 21/442; H04N 21/845; H04N 21/422; H04N 21/81; H04H 60/33; H04H 60/46

(52) U.S. Cl. CPC H04N 21/44218; H04H 60/33; H04H 60/46; H04N 21/42201; H04N 21/8133; H04N 21/8456
USPC 725/10

(57) ABSTRACT

A method, apparatus and system for determining viewer reaction to content elements include generating a viewer feedback signal by recording biometric measurements of a viewer's reactions to viewed content, synchronizing the viewer feedback signal with a content metadata signal for the viewed content and correlating the biometric measurements in the viewer feedback signal with respective elements in the content metadata signal to determine a viewer reaction score for the respective elements in the content.

### CROSS REFERENCE TO RELATED APPLICATIONS

This application claims priority from U.S. Provisional Application Ser. No. 61/659,756 filed Jun. 14, 2012, which is incorporated by reference herein in its entirety.

### FIELD OF THE INVENTION

The present principles relate to the delivery of multimedia content to end viewers and more particularly, to a method and apparatus for correlating viewer reaction to closely defined elements in viewed content.

### BACKGROUND OF THE INVENTION

Typically, viewer interest and opinions about a piece of content are obtained through coarse/aggregate forms of feedback (e.g., star ratings, posts on social networks, web browsing and search histories). Several examples of current targeted content systems rely on this kind of feedback, including recommender systems for VoD services such as NETFLIX, targeted advertisement on the web (e.g., GOOGLE.COM), and brand sentiment analysis services (e.g., FIZZIOLOGY.COM)]. It is believed however that fine-grained records of real-time viewer reactions to content can enable richer targeted content applications.

One way of acquiring fine-grained viewer feedback to content is to monitor viewers from cameras/microphones and watch for emotional reactions such as laughter and surprise. Such a system can lead to privacy concerns from viewers worried about being filmed or recorded while performing other activities in front of a TV. Another form of fine-grained feedback data that is less sensitive is the log of viewer interactions with the application that plays the content (i.e., records of DVR operations such as play, pause, and fast forward). This data may be useful to capture viewer interest in certain parts of the movie, but when a group of viewers is sharing the remote control, it may be difficult to identify which viewer generated which operations.

Over the last decade, there has been substantial work on what is now referred to as affective computing, i.e., the measurement and application of viewer data to infer interest and emotions.

### SUMMARY OF THE INVENTION

Embodiments of the present invention address the deficiencies of the prior art by providing a method, apparatus and system for determining viewer reaction to content elements.

In one embodiment of the present invention, method for determining viewer reaction to elements in content includes generating a viewer feedback signal by recording biometric measurements of a viewer's reactions to viewed content, synchronizing the viewer feedback signal with a content metadata signal for the viewed content and correlating the biometric measurements in the viewer feedback signal with respective elements in the content metadata signal to determine a viewer reaction score for the respective elements in the content.

In an alternate embodiment of the present invention, a system for determining viewer reaction to elements in content includes a biometric sensor configured to record biometric measurements of a viewer as the viewer is watching the content and to generate a viewer feedback signal using the biometric measurements and an apparatus configured to synchronize the viewer feedback signal with a content metadata signal for the viewed content and correlate the biometric measurements in the viewer feedback signal with respective elements in the content metadata signal to determine a viewer reaction score for the respective elements in the content.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system and apparatus for determining viewer reaction to content elements in accordance with an embodiment of the present invention;

FIG. 2 depicts a high level flow diagram of a method for correlating viewer feedback data with content metadata in accordance with an embodiment of the present invention;

FIG. 3 depicts a high level block diagram of a correlation block capable of implementing the method of FIG. 2 in accordance with an embodiment of the present invention;

FIG. 4 depicts a high level schematic block diagram of a process for re-sampling within the correlation block of FIG. 3 in accordance with an embodiment of the present invention; and

FIG. 5 depicts a flow diagram of a method for correlating viewer reaction to elements of content in accordance with an embodiment of the present invention.

### DETAILED DESCRIPTION OF THE INVENTION

Embodiments of the present invention advantageously provide a method, apparatus and system for determining viewer reaction to content elements which can be used to aide in the targeting of content or advertising to viewers. Although the present invention will be described primarily within the context of movie content, the specific embodiments of the present invention should not be treated as limiting the scope of the invention. It will be appreciated by those skilled in the art and informed by the teachings of the present invention that the concepts of the present invention can be advantageously applied within any device having similar capabilities and to substantially any content.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

Furthermore, because some of the constituent system components and methods depicted in the accompanying drawings can be implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

Briefly, in accordance with various embodiments of the present invention, there is provided a method and apparatus for correlating closely defined and measured viewer feedback/reaction data to closely defined content metadata to more closely associate viewer reactions to specific elements of content. The method and apparatus of the present invention enable applications that personalize different aspects of content consumption such as content recommendations and ad placement, as well as provide fine-grained analytics to content producers about viewer/audience reactions to content.

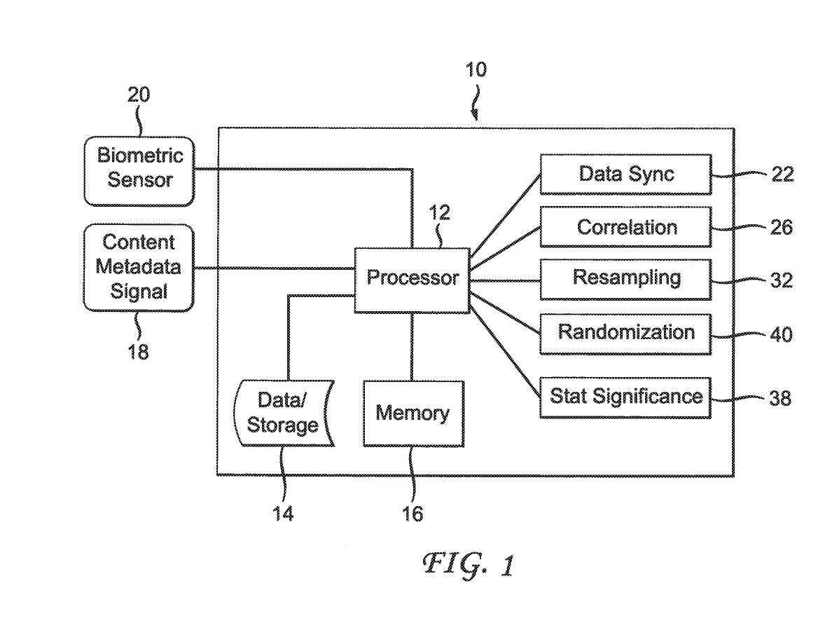

FIG. 1 depicts a high level block diagram of a system for determining viewer reaction to content elements in accordance with an embodiment of the present invention. The system of FIG. 1 includes an apparatus 10 illustratively including at least one processor 12, data/storage 14 and at least one memory device 16. The apparatus 10 of FIG. 1 further illustratively includes a data sync block 22, a correlation block 26, a resampling block 32, randomization block 40, and a statistical significance block 38. The system of FIG. 1 further includes a biometric sensor 20, which obtains biometric measurements of viewer reactions to viewed content for use in the apparatus 10. The processors 12 of the apparatus 10 of FIG. 1 make up a processing means, which can include multiple processors with memories, etc. FIG. 1 further depicts a content metadata signal 18 as an input to the apparatus 10, which will be described in further detail below. Although in FIG. 1 the data sync block 22, the correlation block 26, the resampling block 32, the randomization block 40, and the statistical significance block 38 are depicted as blocks, it should be noted that such functions can be performed using dedicated hardware as well as hardware capable of executing software in association with appropriate software or equivalents thereof. The same applies to all of the Figures presented herein.

In various embodiments of the present invention, such as the embodiment of FIG. 1, the biometric sensor monitors various human responses. Some examples of these monitored human responses can include, for example, heart rate, skin conductance, electroencephalography data, etc. Those of skill in the art will appreciate that other biometric sensing can be performed without departing from the intended scope of this invention. For example, some other human behavior that can be measured by one or more biometric sensors can include body temperature, brain wave activity, eye movement, pupil dilation, etc. The biometric sensor provides a viewer feedback signal of biometric measurements of viewer reactions to viewed content that are used to performs other calculations and considerations in the determination of viewer reactions to elements in content which are defined in content metadata as described herein. Examples of such calculations and considerations, which will be described in more detail below, include, for example, data synchronization 22, correlation 26, resampling 32, randomization 40 and statistical significance 38.

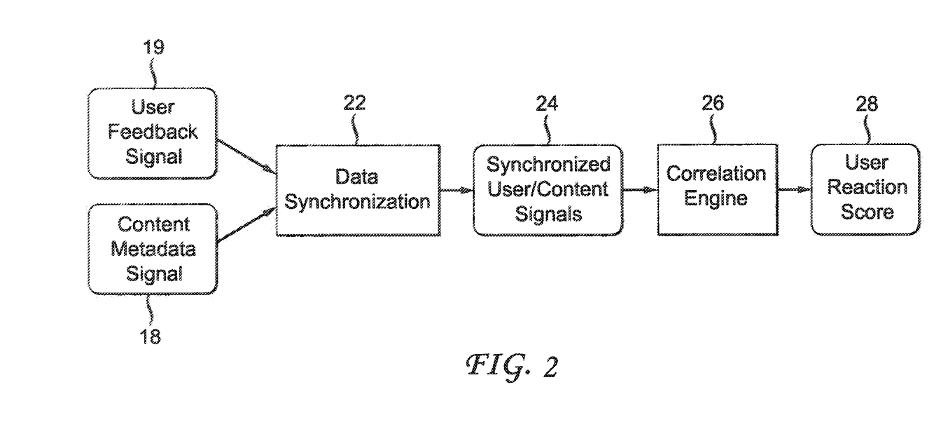

FIG. 2 depicts a high level schematic diagram of a process for correlating viewer feedback data with content metadata in accordance with an embodiment of the present invention. In the embodiment of FIG. 2, a viewer feedback signal 19 is synchronized with a content metadata signal 18 in a data synchronization block 22. In one embodiment of the present invention, the viewer feedback signal comprises a time series of data points (biometric measurements) collected from a biometric sensor 20 in raw form. In alternate embodiments of the present invention, the viewer feedback signal comprises a post-processed feature computed from one or more viewer feedback signals. Examples of raw biometric sensor data include heart rate, skin conductance, and electroencephalography data. Examples of post-processed features include filtered versions of the aforementioned raw signals (e.g., to remove noise or isolate peaks) as well as combinations of data from multiple viewers (e.g., the average heart rate from an audience in a movie theater across the time span of the movie session).

In various embodiments of the present invention, the content metadata signal 18 comprises a time series that describes specific characteristics of content and is computed from either the content (audio/video variables such as spectral coefficients or color histograms) or from high-level characteristics of the content such as a location in the content during which an actor appears, and/or the appearance of specific objects in the content and/or the appearance of specific locations in the content. Those of skill in the art will appreciate that most content is transmitted with content metadata, however, the details of such content metadata can change depending on the provider of the content and/or for whom the content is intended. As such, the method, apparatus and system of embodiments of the present invention are intended to be used with content metadata signals which are configured as a time series describing a specific characteristic of the content. For example, the content metadata of the present invention can include information regarding at what point/time in the content an actor or object appears and/or at what point/time in the content a specific location is shown. It is herein contemplated, however that the content metadata signals 18 can include several time series describing several specific characteristics of the content.

In embodiments of the present invention, the two signals (i.e., the viewer feedback signal 19 and the content metadata signal 18) are synchronized using the the data synchronization block 22, which ensures that timestamps in the viewer feedback 19 and content metadata 18 signals have a same reference point and are in synchronization. In one embodiment of the present invention, this can be achieved by identifying a first data point in the viewer feedback signal that occurs after the beginning of the content such as a movie or other multimedia content. The output of the data synchronization block 22 is a pair of synchronized viewer feedback and content metadata signals 24.

The correlation block 26 receives the synchronized signals 24 and computes a viewer reaction score 28, which can be used to measure how much a viewer reacted to the content element identified by the content metadata signal. In various embodiments of the present invention, the viewer reaction score 28 can comprise a percentage of a whole or a number depicting a placement within a range or any other form of score that depicts a comparison among a possible range of outputs.

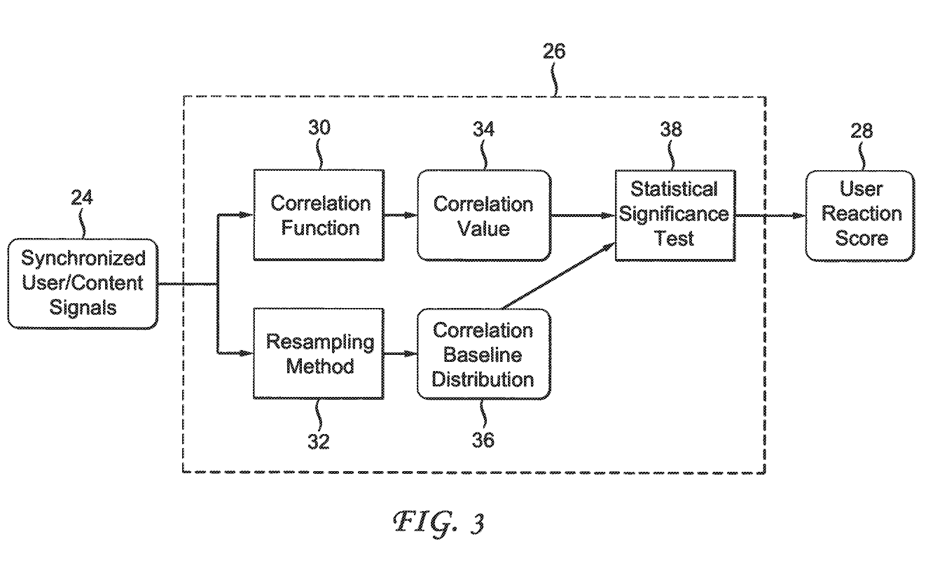

FIG. 3 depicts a high level block diagram of a correlation block 26 in accordance with an embodiment of the present invention. In one embodiment of the present invention, the synchronized viewer feedback and content metadata signals 24 are communicated to a correlation function block 30 and a resampling method block 32 of the correlation block 26 of FIG. 3. The correlation function block 30 computes a correlation value 34. In various embodiments of the present invention, the correlation function block 30 can apply different functions including a simple convolution between the two signals—if the signals are represented as vectors of equal dimension; this is equivalent to the dot product between the two vectors. In one embodiment of the present invention, the correlation value 34 is a real-valued number, which denotes the magnitude of the correlation between the viewer reaction and the content signal. There are some challenges, however in interpreting the correlation value 34 as a raw metric of viewer reaction. First there is a scaling issue: the range of values for the correlation function 30 can depend on statistical properties of the viewer and content signals and, because of this, it may be impossible to compare the correlation values of different pairs of viewer reaction and content signals. Second, it can be difficult to determine whether a given correlation value is statistically significant, for example that an apparently large correlation value is not just the result of randomness and noise in the input signals.

In one embodiment of the present invention, in order to assess the statistical significance of the correlation value 34, the viewer feedback and content metadata signals are communicated to a resampling block 32, which performs a resampling method that computes a non-parametric estimate of a correlation baseline distribution 36. Using this baseline distribution 36, a statistical significance test 38 is performed by computing a probability estimate that a correlation baseline distribution value 36 exceeds the reference correlation value 34 computed in the correlation function block 30. The smaller this probability estimate, the less likely that the observed correlation value is caused by noise, and therefore, the more likely the viewer reaction and content signals are indeed correlated to each other. This value is used to compute a Viewer Reaction Score 28 using a non-increasing function of the probability estimate produced in the statistical significance test 38 so that low probability estimates correspond to high viewer reaction scores and vice-versa.

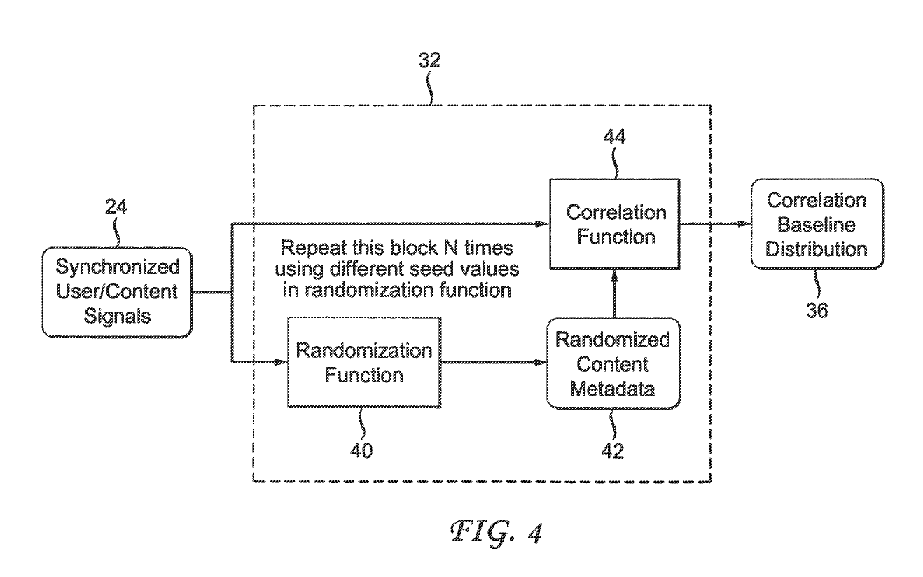

FIG. 4 depicts a high level schematic block diagram of a process for re-sampling within the correlation block of FIG. 3 in accordance with an embodiment of the present invention. The synchronized viewer feedback/content metadata signal 24 is communicated to a randomization function block 40 which outputs a randomized content metadata signal 42. The purpose of the randomization function block 40 is to destroy any existing correlation between the viewer and content signals, so that when the correlation function is re-evaluated, an estimate of the baseline correlation value 44 is obtained. In various embodiments of the present invention, the randomization function block 40 can be implemented in different ways, including as a random permutation of the data points in the signal, or as a cyclic permutation (where a fixed number of data points is removed from the beginning of the signal and re-added to the end of the signal). In one embodiment of the present invention, in order to estimate the full distribution of baseline correlation values, the randomization function block 40 must be applied several times using different random seed values to generate different permutations of the content metadata and thus different baseline values for the correlation value. In such embodiments, in order to estimate the correlation baseline distribution 36, the empirical cumulative distribution function (CDF) of the random samples produced by the correlation function 44 are computed after repeated iterations of the randomization function block 40.

The concepts of the present invention can be used in various applications including viewer profiling for, for example, personalized services or movie audience feedback analytics. Personalized services (e.g., recommender systems and targeted advertisement) generally require data about viewer preferences and preferences for content. For example, if a recommender system knows that a viewer reacts positively to movies containing a specific actor, or filmed in a given location, then such a system can recommend other movies with similar characteristics. Obtaining fine-grained scores for an amount a viewer reacts to different elements of a movie can enable better viewer profiles for these personalized services.

In one embodiment, viewer feedback signals are monitored by wearable devices containing biometric sensors while the viewer watches a movie at home. For example, heart rates and skin conductance can be conveniently measured from a viewer's wrist using, for example, a wristwatch that contains such sensors. Viewer feedback data is then transferred to and stored at a control point managed by the personalization service, for example, in a home gateway or in the cloud. The control point would have a pre-computed database of fine-grained content metadata signals, including the presence of different actors, objects, and locations in content.

The method for correlating viewer feedback and content metadata signals in accordance with embodiments of the present invention is executed using the information contained in the control point, thus assigning viewer reaction scores for respective metadata signals (e.g., each actor in the cast, etc) in the content. Each metadata signal from the content (e.g., movie) is then added to the viewer's profile together with its respective viewer reaction score.

Movie studios have an interest in measuring feedback from movie audiences during post-production, for example to aid in making decisions about movie editing and marketing, as well as after a movie is released, for example to aid in, for example, making decisions about making sequels to a specific movie and what to include in a sequel. Typically, this kind of audience feedback testing is done through explicit feedback means, such as text surveys handed out at movie theaters and sentiment analysis on social media posts about a movie. Using fine-grained implicit feedback in accordance with the embodiments of the present invention as described herein, movie studios can obtain more precise information on which scenes and which elements of a movie triggered reactions in an audience member.

In test screening before a movie release, a studio selects participants from the audience according to criteria such as the target demographics for the movie. In an application of an embodiment of the present invention, wearable devices with biometric sensors can be distributed to audience participants and, optionally, the participants can also be given text surveys. After the screening, biometric sensor data is collected from each audience participant's biometric sensor and communicated to a device of the present invention, as described above, wherein the viewer feedback data is correlated with content metadata to determine the magnitude of respective reactions of the audience participants. In addition to computing the reaction scores for each viewer, in accordance with the present invention, an aggregate measure of viewer feedback can be determined, such as the average feedback signal across the audience, to measure the overall audience reaction to a movie. Individual viewer reactions scores can also be correlated with demographics from the audience to identify how reactions change across age, group, and location of audience participants.

Advantageously, embodiments of the present invention can be used to determine and quantify viewer reactions to detailed elements of the content, instead of obtaining coarse forms of feedback (e.g., star ratings on surveys) for an entire movie or other multimedia content.

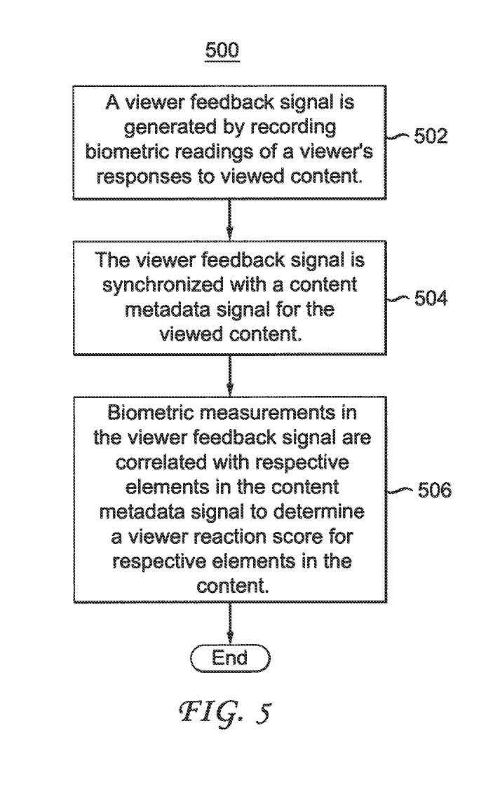

FIG. 5 depicts a flow diagram of a method for determining viewer reaction to elements of content in accordance with an embodiment of the present invention. The method 500 of FIG. 5 illustratively begins at step 502 during which a viewer feedback signal is generated by recording biometric readings of a viewer's responses to viewed content. More specifically and as described above, in one embodiment of the present invention, a biometric sensor is attached to a viewer of content and biometric measurements are taken of the viewer while watching video content to generate a viewer feedback signal representative of the viewer's reactions to elements of the content. The method 500 then proceeds to step 504.

At step 504, the viewer feedback signal is synchronized with a content metadata signal for the viewed content. More specifically and as described above, a content metadata signal is provided for the content, the content metadata identifying locations/times in the content during which specific elements such as actors, objects and/or locations appear in the content. The method 500 then proceeds to step 506.

At step 506, biometric measurements in the viewer feedback signal are correlated with respective elements in the content metadata signal to determine a viewer reaction score for respective elements in the content. The method 500 can then be exited.

Having described various embodiments of a method, apparatus and system for determining viewer reaction to content elements (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A system for determining viewer reaction to elements in content comprising:
a biometric sensor configured to record biometric measurements of a viewer as the viewer is watching the content and to generate a viewer feedback signal using the biometric measurements; and
an apparatus configured to:
synchronize the viewer feedback signal with a content metadata signal for the viewed content; and
correlate the biometric measurements in the viewer feedback signal with respective elements in the content metadata signal to determine a viewer reaction score for the respective elements in the content.

2. The system according to claim 1, wherein the biometric measurements comprise at least one of the viewer's heart rate, skin conductance, and electroencephalography data.

3. The system according to claim 1, wherein the synchronizing of the viewer feedback signal and content metadata signal comprises identifying time stamps in the viewer feedback signal and the content metadata signal and aligning said time stamps to have a same reference point.

4. The system according to claim 1, wherein correlating the biometric measurements in the viewer feedback signal with respective elements in the content metadata signal, comprises:
computing a correlation value indicating a magnitude of correlation between the viewer feedback signal and the content metadata signal;
computing a correlation baseline distribution value of the viewer feedback signal and the content metadata signal; and
performing a statistical significance test using the correlation value and the correlation baseline distribution value, said statistical significance test determining the viewer reaction score.

5. The system according to claim 4, wherein computing the correlation baseline distribution value comprises resampling the synchronized viewer feedback signal and the content metadata signal.

6. The system according to claim 5, wherein resampling the synchronized viewer feedback signal and the content metadata signal comprises:
i) performing a randomization function on the content metadata signal to destroy any existing correlation between the viewer feedback signal and the content metadata signal, said randomization function determining a randomized content metadata signal;
ii) performing a correlation function on the randomized content metadata and the viewer feedback signal; and
iii) repeating steps i) and ii) using different seed values for the randomization function.

7. The system according to claim 6, wherein the resampling results in a nonparametric estimate of the correlation baseline distribution value.

8. A method for determining viewer reaction to elements of content, comprising:
generating a viewer feedback signal by recording biometric measurements of a viewer's reactions to viewed content;
synchronizing the viewer feedback signal with a content metadata signal for the viewed content; and
correlating the biometric measurements in the viewer feedback signal with respective elements in the content metadata signal to determine a viewer reaction score for the respective elements in the content.

9. The method according to claim 8, wherein generating a viewer feedback signal comprises monitoring a viewer's response to content using a biometric sensor.

10. The method according to claim 9, wherein the viewer feedback signal comprises a biometric measurement of at least one of the viewer's heart rate, skin conductance, and electroencephalography data.

11. The method according to claim 9, wherein said synchronizing comprises identifying time stamps in the viewer feedback signal and the content metadata signal and aligning said time stamps to have a same reference point.

12. The method according to claim 8, wherein said correlating comprises:
computing a correlation value indicating a magnitude of correlation between the viewer feedback signal and the content metadata signal;
computing a correlation baseline distribution value of the viewer feedback signal and the content metadata signal; and
performing a statistical significance test using the correlation value and the correlation baseline distribution value, said statistical significance test determining the viewer reaction score.

13. The method according to claim 12, wherein said computing a correlation baseline distribution comprises resampling the synchronized viewer feedback signal and the content metadata signal.

14. The method according to claim 13, wherein said resampling comprises:
i) performing a randomization function on the content metadata signal to destroy any existing correlation between the viewer feedback signal and the content metadata signal, said randomization function determining a randomized content metadata signal;
ii) performing a correlation function on the randomized content metadata and the viewer feedback signal; and
iii) repeating steps i) and ii) using different seed values for the randomization function.

15. An apparatus for determining viewer reaction to elements of content, comprising:
a data synchronization means for synchronizing a viewer feedback signal with a content metadata signal for the viewed content; and
a correlation means for correlating biometric measurements in the viewer feedback signal with respective elements in the content metadata signal to determine a viewer reaction score for the respective elements in the content.

16. The apparatus of claim 15, comprising a resampling means configured to:
i) perform a randomization function on the content metadata signal to destroy any existing correlation between the viewer feedback signal and the content metadata signal, said randomization function determining a randomized content metadata signal;
ii) perform a correlation function on the randomized content metadata and the viewer feedback signal; and
iii) repeat steps i) and ii) using different seed values for the randomization function.

17. The apparatus of claim 15, comprising a statistical significance means configured to:
compute a correlation value indicating a magnitude of correlation between the viewer feedback signal and the content metadata signal;
compute a correlation baseline distribution value of the viewer feedback signal and the content metadata signal; and
perform a statistical significance test using the correlation value and the correlation baseline distribution value, said statistical significance test determining the viewer reaction score.

18. The apparatus of claim 15, where said data synchronization means identifies time stamps in the viewer feedback signal and the content metadata signal and aligns said time stamps to have a same reference point.
